(19) United States
(12) Patent Application Publication
(10) Pub. No.: US 2007/0287141 A1
(43) Pub. Date: Dec. 13, 2007

(54) Internet based client server to provide multi-user interactive online Karaoke singing

(76) Inventor: Duane Milner, Omro, WI (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/432,708

(22) Filed: May 11, 2006

(51) Int. Cl. G09B 5/00

(52) U.S. Cl. 434/307 A

(57) ABSTRACT

A distributed online system for enabling an end user with a browser to play karaoke comprising an end user installation with internet browser, a central host server accessible to the end user via the browser for providing the end user with access to at least one independently hosted karaoke chat room server, with said chat room server being authorized by the host server and accessible by the end user for providing the end user with a karaoke application.

### FIELD OF THE INVENTION

The present invention is directed towards an Internet client/server method and system for online, real-time, interactive Karaoke performances in a streaming audio or streaming video format. The software is designed specifically to integrate all the necessary components of Karaoke so that it can be performed online.

### BACKGROUND OF THE INVENTION

The phenomenon of Karaoke entertainment in the United States and worldwide is becoming a popular entertainment trend. Karaoke is an attractive pastime for many reasons. It allows the user to role-play as the singing star they may have wanted to become, to emulate their favorite entertainers, or simply entertain themselves and or others by singing along with their favorite music. Karaoke started in Japan and has become very popular in the United States and around the world and is now available in almost every single language. The first format for Karaoke was actually on audiocassette tape; however, that format was limited because it did not have any lyrics available for the singer except on printed sheet music.

The Karaoke industry is relatively new to the U.S. compared with Japan, and owners and operators of professional karaoke entertainment equipment are fewer in number. Most of the karaoke entertainment operators have significant investments in equipment. The format of this equipment rapidly changes, making the cost to own the equipment prohibitive for the average user. There are many American bars that have karaoke nights or special karaoke events. Very few of these establishments offer karaoke every night, thus limiting access to this service. Other drawbacks include the lack of a controlled environment, travel time lost, limited access to the equipment once you get there, lack of song selection, and the lack of control over the type of music played.

In the early 1990's the Pioneer Corporation created 12″ Karaoke Disks in laser format similar to the Laser Video disks for popular movies. The Laser format was very popular since the lyrics to the accompaniment music could be played on a TV screen in time with the music. This made it very easy for a Karaoke singer to “sing-along”. In addition, the Laser format had the added feature of a background video and in many cases displayed images that complemented the style and mood of the song. All laser disk players would play the karaoke disks but not all laser disks had microphone inputs for mixing the singer and the accompaniment so Pioneer introduced special laser disk karaoke players. The small production runs of Laser Karaoke players and Laser Karaoke disks made the laser disks format no longer predominate the Karaoke industry. Another competing Karaoke format was introduced at about the same time as CD plus graphics or CDG.

The 5″ CDG format is very similar to the audio CD format in size and technology, with the exception of one difference. CDG karaoke disks contain an additional track that first plays the song lyrics in graphics on a TV and they are smaller and less expensive than the laser disks. CDG Karaoke disks, however, have no moving picture video in the background. The words comprising the lyrics are typically displayed on a blue background and are highlighted in a contrasting color to signal when the words should be sung (the modern version of “following the bouncing ball”). The CDG format is the Karaoke standard today for most of the world's Karaoke.

As with the laser disks, the CDG karaoke disk requires a special Karaoke Player called a Karaoke CDG Player. The Karaoke CDG player is similar to a regular CD audio player except that it has a “G” chip for reading the graphics track. In addition, a CDG karaoke player also has microphone inputs and a key controller to adjust for the singer's key and an echo control to enhance the singer's voice.

Recently, another karaoke disk format has emerged called Video CD. With the exception of size, this 5″ disk format is not like CD Audio or CDG disks. Video CD is MPEG 2.0 format. Both of these formats are designed for motion picture displays but have been adapted for Karaoke. Video CD is most popular in Southeast Asia and in the United Kingdom, but it is gaining on the CDG format in the United States. Like Laser Karaoke Disks, Video CD Karaoke disks provide not only the lyrics in time with the accompaniment, but also a video background display that complements the song. This format is very inexpensive with disks, which are about half the price of CDG disks. However, what is needed to play video CD disks is either a CDG Karaoke player that has Video CD capabilities or a DVD player since all DVD players can play video CD format. Many CDG karaoke players are combination Video CD and CDG formats and operate the same way as a regular CDG Karaoke player.

DVD Karaoke disks were introduced in 1998. Most of the DVD karaoke disks are replications of the video CD karaoke disks or the older laser karaoke disks. The video background capability on a DVD karaoke disk is much higher than a video CD disk or Laser disk but there are few added music or sound qualities or special DVD features. The DVD Karaoke disks tend to be priced higher and there is less of a selection of songs. A special DVD Karaoke Player is needed to mix the vocals and the accompaniment.

A number of patents have issued in the area of karaoke programs. U.S. Pat. No. 6,516,323 discloses a telecom karaoke system is configured by linking a musical data receiving terminal for receiving from a host base station necessary data for musical performance and a WWW page access terminal for accessing a page or a document on WWW via a WWW server. In this configuration, the musical data receiving terminal sequentially transmits to the WWW page access terminal the addresses of pages on WWW, superposed on the musical data. Further, the WWW page access terminal, when a musical number is selected, notifies the information on music selection to the data receiving terminal and, at the same time, updates data related to the musical number (a list of the number of accesses and the like) on the WWW server.

U.S. Pat. No. 6,074,215 discloses a karaoke online system distributes karaoke data blocks having identification codes from a center station to a plurality of karaoke terminals through a broadcast network. In the center station, a transmitter broadcasts the karaoke data blocks with the identification codes to the broadcast network. In the karaoke terminal, a receiver receives the karaoke data blocks with the identification codes from the center station through the broadcast network. A buffer memory temporarily memorizes each of the karaoke data blocks received by the receiver. A storage device stores the karaoke data blocks after each of the karaoke data blocks is temporarily memorized in the buffer memory. A controller discriminates the karaoke data blocks while each of the karaoke data blocks stays in the buffer memory according to the identification codes attached to the karaoke data blocks for judging as to whether each of the karaoke data blocks should be transferred from the buffer memory to the storage device. The controller further operates when judging that the karaoke data block should be transferred for driving the storage device to store the karaoke data block.

U.S. Pat. No. 6,537,078 discloses an entertainment system for storing, transmitting and displaying music, pictures and sound from videos and audios in any format for users to sing or act along with. The entertainment system includes an entertainment center having a central computer and server, a hardswitch connected to the central computer and server, and a converter connected to the hardswitch; and at least one user sub-station location having a plurality of individual karaoke player rooms. The entertainment system also includes a remote library source of videos/audios on any format having T1 bandwidth lines for transmitting to the entertainment center; and the entertainment center also having T1 bandwidth lines for transmitting to at least one of the user sub-station locations. The converter includes a karaoke video disc player for converting the received audio/video into a desired karaoke formatted song, play or movie. Each of the karaoke player rooms includes a workstation for selecting the desired karaoke formatted song, play or movie, a viewing monitor for displaying the selected videos/audios in the converted karaoke formatted songs, play or movie, a karaoke microphone for the user to sing or act into, and a video camera for recording the user's performance. At least one of the user sub-station locations includes a communication device and a storage device in the form of a network router, a modem and server for interfacing with the workstations.

U.S. Pat. No. 5,768,396 discloses a karaoke system of an online type is comprised of a karaoke station for sounding a karaoke performance according to a performance data, and a host station for supplying the performance data to the karaoke station in response to a request. The host station has a transmitter unit for time-sequentially dividing the performance data into a plurality of parts, and for successively transmitting each part arranged according to progression of the karaoke performance in response to the request. The karaoke station has a receiver unit operative when a preceding one of the transmitted parts is received for commencing the karaoke performance based on the received preceding part while admitting a succeeding one of the transmitted parts in parallel to sounding of the karaoke performance to thereby maintain continuous progression of the sounding of the karaoke performance.

U.S. Pat. No. 5,663,515 discloses a karaoke online system is composed of a karaoke station and a karaoke terminal telecommunicable with the karaoke station. The karaoke station has a database for storing a plurality of performance data files corresponding to a plurality of karaoke songs, each performance data file containing a sequence data which time-sequentially designates musical tones of the corresponding karaoke song. A selector responds to a request command transmitted from the karaoke terminal for selecting a performance data file of a karaoke song designated by the request command. A transmitter transmits the sequence data contained in the selected performance data file to the karaoke station in synchronization with a predetermined tempo of the designated karaoke song. On the other hand, the karaoke terminal transmits the request command to the karaoke station upon a request of the designated karaoke song to be performed. Further, a performing unit receives the sequence data transmitted from the transmitter and directly drives an internal tone generator in response to the received sequence data to thereby generate the musical tones of the designated karaoke song according to the predetermined tempo in real-time basis.

U.S. Pat. No. 5,953,005 discloses a method and system for providing access to multimedia content on-line which is updated virtually simultaneously with the vendor's update process. By a user accessing a page on the World Wide Web, for example, data (encrypted and unencrypted) and instructions are automatically downloaded to a user's computer system for quick access. Depending upon the user's computer system (LAN or a stand-alone personal computer), “applets” containing data and instructions are stored for immediate access. In a Karaoke application of this invention, where the user desires to access songs which are most popular at a given time, the user accesses a page where a song list and other information is displayed on a display apparatus. When the user clicks on a particular song of the song list, the applet executes an authentication request. If the user is authenticated, the authentication is downloaded as part of the applet containing the desired multimedia content (or separately depending upon the circumstances). According to this invention, an applet includes multimedia elements which further include timing codes and a synchronization function which provides for the synchronization of the delivery of the multimedia elements.

U.S. Pat. No. 6,137,047 discloses an electronic apparatus is constructed by various devices for collectively executing a task. The electronic apparatus uses at least one electronic circuit device containing a plurality of circuit elements which are reconfigurable into a desired connection mode so as to perform an allotted function during the course of executing the task. Further, in the electronic apparatus, a communication device operates when the allotted function of the electronic circuit device is to be altered. The communication device downloads, from a communication network, circuit design information effective to determine the connection mode of the circuit elements contained in the electronic circuit device. A control device reconfigures the connection mode of the circuit elements in accordance with the downloaded circuit design information to thereby alter the allotted function of the electronic circuit device.

U.S. Pat. No. 6,692,259 discloses an interactive karaoke system which includes a microphone developing an audio input from at least one karaoke performer; a camera producing a series of video frames including the at least one karaoke performer; and a karaoke processor system including a video environment and a related audio environment for the karaoke performer. The karaoke processor system is coupled to the camera to create extracted images of the at least one karaoke performer from the series of video frames and to composite the extracted images with a background derived from the video environment. The video environment is affected by at least one of a position and a movement of the at least one karaoke performer. A karaoke network includes a local area network, a local karaoke server coupled to the local area network and storing local karaoke content; and a number of karaoke systems coupled to the local area network, each of which can request karaoke content from the local karaoke server.

U.S. Patent Application No. 20020194356 discloses a system and method of downloading and playing the downloaded music files comprising a music website that provides, through a network, music files with searchable indexing page, and a plurality of information terminals that are capable of communicating with the music website through the network and downloading and playing the music files downloaded from the music website. If it is a karaoke song, the music file is marked with position indictor at each point of changing word of lyrics along with melody of the song for synchronization. The music files will be removed from the memory of information terminal after online playing. For offline playing, the music files are encrypted when being downloaded, and will be decrypted at the information terminal for playing with verification of correct encryption key stored in the information terminal. The encryption key is created and updated regularly with the update of the virtual amplifier so as to prevent the user from distributing freely the downloaded music files.

U.S. Patent Application No. 20040019527 discloses a Customer Media Replay System (CMRS) that supports the sale of customized versions of a performing art record, mainly but not limited to music, video and data files. The customization process occurs at the seller's and customer's sides. At the seller's side, CMRS keeps the original multitrack/multimedia records (master records) from which it produces customized versions according to the customer's acoustic profile and/or preferences, and the sale's conditions. At the customer's side, the system creates the customer's acoustic profile based on the customer's reproducer device's capabilities and the environmental acoustic characteristics where the music or media files will be replayed.

U.S. Patent Application No. 20020148344 discloses “AN ARRANGEMENT MADE TO AN AUDIO VISUAL DEVICE CONNECTED TO INTERNET” being constituted of an audio visual device of Karaoke (1) that works in a way similar to other devices and can be connected to a TV set as the usual equipment is connected and said equipment was exclusively developed to be connected to Internet, which is used both via satellite, Cable TV, radio, medium and short waves or telephone line and to only one Site specially adapted to offer several advantages amongst them we could cite that user can buy songs by units therefore avoiding to be subjected to cartridges and CDs; and said user can further get a sound and image quality even better than those offered by the usual systems; in addition to this, the launches of songs on the market that were not quickly available for the ancient equipment can now be immediately obtained through an uncommon way; to have such songs via Internet, user shall make “download” through a simplified procedure; this makes the equipment to be a device easily handled, much more efficient and with a cost lower than any traditional pattern; the internal construction of said equipment requires a Modem and a computer system to provide the connections of said equipment to the dedicated Site, the equipment is also externally provided with connection buttons navigation buttons sound and image regulating buttons microphone ancillary inputs Leds and Audio Visual devices in order to make possible the connection to Internet and the perfect working of said device it has been provided with a power cable telephone line input, video output and ancillary input for audio and video

U.S. Patent Application No. 20020127527 discloses a communication system is proposed for transmitting at least one of the data, the program, and a combination of them from a host facility to a communicator such as a communication terminal device. In this communication system, the data or the program becomes unable to be used when a predetermined time has elapsed after it is transmitted from the host facility to the communicator. This communication system is provided with the function of giving a warning before the use of the transmission becomes unable and the function of resuming the use in accordance with the user's instruction even after the use becomes unable.

While there have been number of prior other systems directed to karaoke systems, including online systems, there has not been a system for enabling an online karaoke in an online community environment. One of the problems with online karaoke has been the problem of bandwidth.

It is an object of the present invention to provide an online system which functions in an online karaoke community.

It is a further object of the present invention to provide an online option allowing members to create karaoke rooms.

It is yet a further object of the present invention to present invention to provide an online community of karaoke players.

It is an additional object of the present invention to provide an online karaoke application by which the bandwidth requirements of the system can be distributed.

### SUMMARY OF THE INVENTION

In accordance, the present invention distributes an online system for enabling an end user with a browser to play karaoke comprising of an end user work station with an internet browser; and a central host server accessible to the end user via the browser for providing the end user with access to at least one independently hosted karaoke chat room server, said chat room server authorized by the host server and accessible by the end user for providing the end user with a karaoke application.

In a further embodiment, the invention is a distributed online system for enabling an end user with a browser to play karaoke comprising of an end user installation with internet browser and microphone, a central host server accessible to the end user via the browser for providing the end user with access to at least one independently hosted karaoke chat room server, said chat room server authorized by the host server and accessible by the end user for providing the end user with a karaoke application via the end user's microphone.

In still a further embodiment, the invention is a distributed online system for enabling an end user with a browser to play karaoke comprising of an end user workstation with an internet browser, a central host server accessible to the end user via the browser for providing the end user with access to at least one independently hosted karaoke chat room server, said chat room server authorized by the host server and accessible by the end user for providing the end user with a karaoke application and providing a list of users.

### BRIEF DESCRIPTION OF THE FIGURES

FIG. 1 is a block diagram of the Karaoke room of the present invention.

FIG. 2 is a sign in screen in accordance with the present invention.

FIG. 3 is a central host screen website and connection for chat rooms.

FIG. 4 illustrates the interface of the end user with the chat room and other end users.

FIG. 5 is an illustration of the chat room screen of the present invention.

### DESCRIPTION OF THE PREFERRED EMBODIMENT

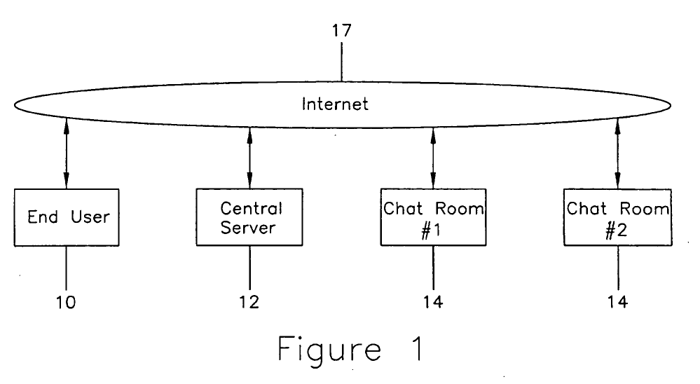

The present invention is directed to a system and method whereby an online Karaoke method and system are specifically designed to develop a community of online karaoke singers or performers through an integrated singing or performing room as opposed to using a chat room that is designed for general chat or video chat applications. Referring to FIG. 1, the present invention comprises of end users 10 who connect to a central server 12 and a plurality of independent chat rooms 14 by internet 17. Each end user is a member or subscriber to a web service which is based on the central server 12. The end user typically has a personal computer or similar device, a monitor and a browser application. The end user will also have a microphone and optionally, a video camera.

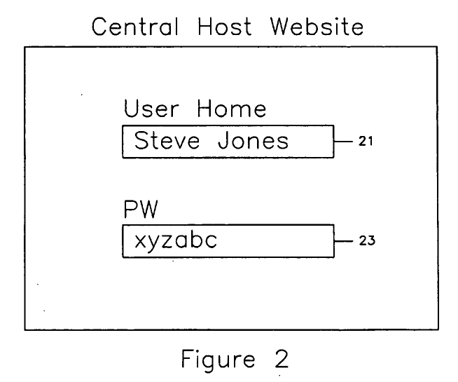

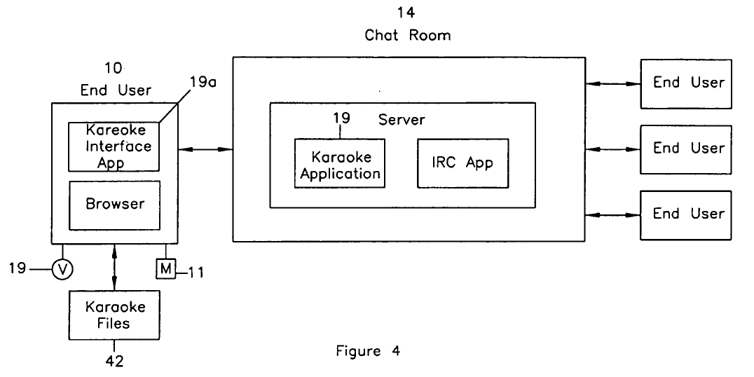

Referring to FIG. 2, the present invention comprises of a distributed online system whereby multiple individuals can participate in an online client room with karaoke. As shown in FIG. 4, the system includes an end user 10 who has a PC or a similar device with the internet browser software. In operation, the end user will contract with the central server 12, which may be associated with a third party website such as KaraokeBoulevard.com. The end user will sign up for the service via the central server. Referring to FIG. 2, the end user will select a user name 21 and password 23.

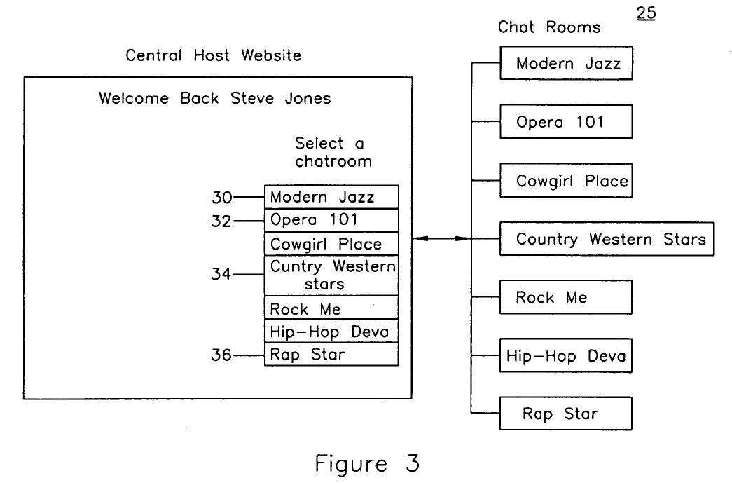

The end user is then admitted within the host system as shown in FIG. 3. Here the end user will be provided with a plurality of chat rooms 25. Each chat room will be hosted independent of the central server. The chat rooms may compromise businesses independent of the host server. Each chat room will typically be directed to a different music genre such as Jazz 30, Opera 32, Country-Western 34, and Rap 36. As the end user signs up for each session, he can choose one of the numerous chat rooms.

Each of the chat rooms is hosted on an independently hosted server with a karaoke player application 38 and an internet relay channel (chat) capability 40.

As shown in FIG. 4, when the end user selects a chat room such as Jazz, the end user will initially access the karaoke player interface application on the chat room server, which will be downloaded onto the end users temporary memory on the end user's computer and which may be viewed on the end user's browser. The interface allows the end user to access an interface with the karaoke player on the chat room server.

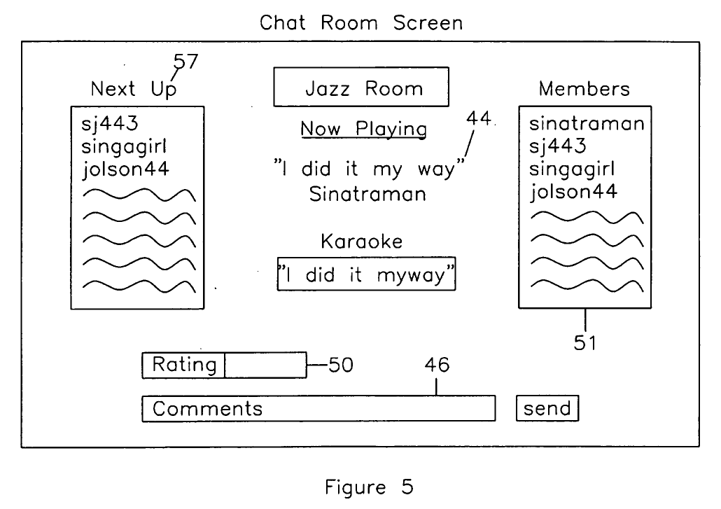

The end user will typically upload a karaoke file 42 to be played from his/her PC hard drive. The end user will then queue in the chat room. Referring to FIG. 5, when the end user is notified, the user will play the sound and sing into a microphone associated with his PC 10, and the audio stream will stream to the chat room via the interface and the host room player. The interface will stream the audio to the chat room where it will be available for all users in the chat room 44. A list of the active members in the room is provided. The invention further contemplates a video component in which the end user 10 can have a video camera 19.

All other end users in the chat room will be able to see and listen to the end user's performance. They will be able to send instant messages or type messages 46 and ratings 50, which will appear in the chat rooms as shown in FIG. 5.

As noted, the server system will not host the music that the users will perform. The chat room participants will provide their own music files for use in the Karaoke forum. Individuals will be allowed to download room server software in order to provide Karaoke room services to registered Karaoke Boulevard members.

As noted, the online audience will interact with the performer via a chat room window, typing in feedback and encouragement to the user. Members of this online audience will be able to take their turn at performing their music by queuing. The room server software will provide a “performance queue” so those that wish to perform can “get in line”. Using the Internet allows the Karaoke performer to maintain as much anonymity as desired while still engaging in an interactive environment to be able to receive feedback on their performance.

The end user can have just the music playing in the background from their favorite song, while the user then supplies the vocals by singing the lyrics. Karaoke software allows users who do not know the words to the song, to sing along by scrolling the lyrics across the screen of a monitor. This allows the user to sing along (Karaoke).

Finally, by distributing the application through independent chat servers, the bandwidth requirements of the invention are distributed.

The present invention has been described with reference to the above discussed preferred embodiment. The true nature and scope of the invention is to be determined with reference to the claims appended hereto.

1. A distributed online system for enabling an end user with a browser to play karaoke comprising:
an end user work station with internet browser;
a central host server accessible to the end user via the browser for providing the end user with access to at least one independently hosted karaoke chat room server; and
said chat room server authorized by the host server and accessible by the end user for providing the end user with a karaoke application.

2. A distributed online system for enabling an end user with a browser to play karaoke comprising:
an end user work station with internet browser and microphone;
a central host server accessible to the end user via the browser for providing the end user with access to at least one independently hosted karaoke chat room server; and
said chat room server authorized by the host server and accessible by the end user for providing the end user with a karaoke application via the end user's microphone.

3. A distributed online system for enabling an end user with a browser to play karaoke comprising:
an end user workstation with internet browser;
a central host server accessible to the end user via the browser for providing the end user with access to at least one independently hosted karaoke chat room server; and
said chat room server authorized by the host server and accessible by the end user for providing the end user with a karaoke application and providing a list of other users.
